(19) United States
(12) Patent Application Publication
(10) Pub. No.: US 2024/0320507 A1
(43) Pub. Date: Sep. 26, 2024

(54) DEVICE, METHOD, AND SYSTEM FOR WEIGHTED KNOWLEDGE TRANSFER

(71) Applicant: HITACHI, LTD., Tokyo (JP)

(72) Inventors: George CHALKIDIS, Tokyo (JP); Shuntaro YUI, Tokyo (JP); Wataru TAKEUCHI, Tokyo (JP)

(21) Appl. No.: 18/271,686

(22) PCT Filed: Mar. 11, 2021
(86) PCT No.: PCT/JP2021/009834

§ 371 Date: Jul. 11, 2023

(51) Int. Cl. G06N 3/096; G06N 3/045

(52) U.S. Cl. CPC G06N 3/096; G06N 3/045

(57) ABSTRACT

Aspects relate to a privacy preserving public machine learning model that achieves high performance while maintaining data privacy. Further aspects relate to a weighted knowledge transfer device including a feature determination unit to generate a public knowledge transfer dataset and a private knowledge transfer dataset; a data selection unit to generate, based on a similarity calculation of the public knowledge transfer dataset and the private knowledge transfer dataset, a public training dataset and a similarity weight vector; a machine learning model management unit to generate, by processing the public training dataset with a set of machine learning models trained based on the private knowledge transfer dataset, a public label vector that indicates labels for the set of public features; and a knowledge transfer unit to generate a public machine learning model based on the weight vector, the public training dataset, and the public label vector.

### TECHNICAL FIELD

The present disclosure generally relates to machine learning techniques, and more particularly relates to a weighted knowledge transfer technique for creating a privacy preserving machine learning model.

### BACKGROUND ART

In recent years, machine-learning approaches for data analysis have been widely explored for recognizing patterns which, in turn, allow for extraction of useful information and insights. Machine learning techniques include algorithms that may be trained to make generalizations based on training data with known outcomes. Once trained, these machine learning algorithms may then be applied to predict the outcome in cases of unknown outcome.

Machine-learning approaches, which may include neural networks, hidden Markov models, belief networks, support vector machines, and the like, are ideally suited for domains characterized by the existence of large amounts of data, noisy patterns and the absence of general theories, and have been applied to a variety of fields including healthcare, finance, and insurance.

Some machine learning applications involve the use of training data that is sensitive, such as the medical histories of patients in a clinical trial. A machine learning model trained on such training data may inadvertently and implicitly store some of this sensitive information, such that careful analysis of the trained model may lead to privacy risks in which sensitive information is obtained by unauthorized actors.

Accordingly, in view of such challenges, methods have been proposed for protecting the privacy of training data. For example, Papernot et al. (Non-patent Document 1) discloses “To address this problem, we demonstrate a generally applicable approach to providing strong privacy guarantees for training data: Private Aggregation of Teacher Ensembles (PATE). The approach combines, in a black-box fashion, multiple models trained with disjoint datasets, such as records from different subsets of users. Because they rely directly on sensitive data, these models are not published, but instead used as “teachers” for a “student” model. The student learns to predict an output chosen by noisy voting among all of the teachers, and cannot directly access an individual teacher or the underlying data or parameters.

The student's privacy properties can be understood both intuitively (since no single teacher and thus no single dataset dictates the student's training) and formally, in terms of differential privacy. These properties hold even if an adversary can not only query the student but also inspect its internal workings. Compared with previous work, the approach imposes only weak assumptions on how teachers are trained: it applies to any model, including non-convex models like DNNs. We achieve state-of-the-art privacy/utility trade-offs on MNIST and SVHN thanks to an improved privacy analysis and semi-supervised learning.”

### CITATION LIST

### Non Patent Literature

NPL 1: Papernot et al. “Semi-supervised Knowledge Transfer for Deep Learning from Private Training Data.” International Conference on Learning Representations 2017. 2017.

### SUMMARY OF INVENTION

### Technical Problem

Non-Patent Document 1 discloses a technique in which a “student” machine learning model is trained not directly on sensitive training data, but instead based on multiple “teacher” models that are each trained on a portion of the sensitive training data. Since these teacher models are not made public, and the student model is not dependent on one single student model or one single data set, information regarding the sensitive training data cannot be extracted from the teacher model by an unauthorized actor. In this way, privacy of the sensitive training data can be facilitated.

The technique disclosed in Non-Patent Document 1, however, lacks the ability to transfer knowledge from a private model to a public model where great variability exists between the private data set used to train the private model and the public data set used to train the public model. For instance, Non-Patent Document 1 does not disclose techniques for generating a knowledge transfer dataset that can be used in the creation of a privacy preserving machine learning model. As a result, Non-Patent Document 1 does not provide a technique for conveying the characteristics of features in private datasets that can be used in the creation of a privacy preserving machine learning model.

Accordingly, it is an object of the present disclosure to provide a device, method, and system for performing a weighted knowledge transfer from a private machine learning model to a public machine learning model in order to create a privacy preserving public machine learning model that achieves high performance while maintaining data privacy.

### Solution to Problem

One representative example of the present disclosure relates to a weighted knowledge transfer device including a data selection unit configured to generate, based on a similarity calculation of a public dataset and a private dataset: a subset of the public dataset that achieves a similarity threshold with respect to the private dataset, and a similarity weight vector that indicates weights of a set of public features included in the subset of the public dataset; a machine learning model management unit configured to generate, by processing the subset of the public dataset with a set of machine learning models trained based on the private dataset, a public label vector that indicates labels for the set of public features; and a knowledge transfer unit configured to generate a public machine learning model based on the weight vector, the subset of the public dataset, and the public label vector.

### Advantageous Effects of Invention

According to the present disclosure it is possible to provide a device, method, and system for performing a weighted knowledge transfer from a private machine learning model to a public machine learning model in order to create a privacy preserving public machine learning model that achieves high performance while maintaining data privacy.

Problems, configurations, and effects other than those described above will be made clear by the following description in the embodiments for carrying out the invention.

### BRIEF DESCRIPTION OF DRAWINGS

FIG. 1 illustrates an example computing architecture for executing the embodiments of the present disclosure.

FIG. 2 illustrates an example configuration of a weighted knowledge transfer system, according to embodiments.

FIG. 3 illustrates an example logical configuration of a weighted knowledge transfer device, according to embodiments.

FIG. 4 illustrates an example of selecting a set of target features for use in creation of the privacy preserving public machine learning model, according to embodiments.

FIG. 5 illustrates an example logical configuration of a weighted knowledge transfer unit for creating the privacy preserving public machine learning model, according to embodiments.

FIG. 6 illustrates a flowchart of a knowledge transfer dataset creation process, according to embodiments.

FIG. 7 illustrates a flowchart of a similarity weighting process, according to embodiments.

FIG. 8 illustrates a flowchart of a weighted knowledge transfer process, according to embodiments.

FIG. 9 illustrates an example logical configuration of a weighted knowledge transfer device according to a second embodiment of the present disclosure.

FIG. 10 illustrates an example logical configuration of the partitioning optimization unit for partitioning a private dataset and generating the set of machine learning models, according to the second embodiment of the present disclosure.

FIG. 11 illustrates a flowchart of a trained machine learning model generation process, according to the second embodiment of the present disclosure.

FIG. 12 illustrates the logical configuration of the weighted knowledge transfer device according to the second embodiment for data selection and optimization of a weighted knowledge transfer.

FIG. 13 illustrates a flowchart of a data thresholding optimization process, according to the second embodiment of the present disclosure.

### DESCRIPTION OF EMBODIMENT(S)

Hereinafter, embodiments of the present invention will be described with reference to the Figures. It should be noted that the embodiments described herein are not intended to limit the invention according to the claims, and it is to be understood that each of the elements and combinations thereof described with respect to the embodiments are not strictly necessary to implement the aspects of the present invention.

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter.

In domains such as healthcare, finance, and insurance, for example, protecting the privacy of personal data is of great importance. Unintended data leaks could have detrimental consequences both for those companies that store the data as well as the individuals from whom the data was collected. As the number of companies offering machine learning services (personal health prediction, financial risk prediction) increase, the need for protecting the privacy of personal data also increases.

In some cases, machine learning applications may involve the use of training data that is sensitive, such as the medical histories of patients in a clinical trial. Those individuals that contribute their personal data for use in training machine learning models do so in good faith, believing that machine learning models that can be accessed by third parties will not expose any of their personal information.

However, malicious actors can hack machine learning models and obtain the personal information of those individuals who contributed the private data that was used to train said machine learning models.

In view of such challenges, privacy preserving configurations can be deployed to prevent leaking private data to malicious actors through the machine learning model. However, using healthcare data as an example, due to the varied nature of private and public data sources, it is challenging to create a privacy preserving machine learning model that achieves similar predictive performance to machine learning models that have been directly trained on private data.

For instance, in order to create a user-facing, privacy preserving, public machine learning model that achieves comparable performance to a private machine learning model, knowledge needs to be transferred from the private model to the public model. Conventional methods, however, lack the ability to transfer knowledge from a private model to a public model where great variability exists between a private data set used to train the private model and a public data set used to train the public model. For instance, conventional methods do not disclose techniques for generating a knowledge transfer dataset that can be used in the creation of a privacy preserving machine learning model. As a result, conventional methods do not provide techniques for conveying the characteristics of features in private datasets that can be used in the creation of a privacy preserving machine learning model.

Accordingly, aspects of the present disclosure are directed to addressing the above challenges by creating a public dataset that resembles a private dataset, selecting a set of target features between the private dataset and the public dataset to create a knowledge transfer dataset, allocating weights to convey characteristics found in the private dataset via the knowledge transfer dataset, and performing a weighted knowledge transfer from a private to a public model based on the knowledge transfer dataset and the allocated weights.

Additional aspects of the disclosure relate to determining a partitioning scheme of public data and parameter configurations for a set of machine learning models to optimize knowledge transfer performance. Additional aspects of the disclosure relate to determining a set of thresholds to select a set of public training data from a public knowledge transfer dataset, training a plurality of machine learning models on selected subsets of public data, and selecting thresholds and parameter configurations to optimize the knowledge transfer capacity and the performance of the public model.

In this way, according to the present disclosure, it is possible to provide a device, method, and system for performing a weighted knowledge transfer from a private machine learning model to a public machine learning model in order to create a privacy preserving public machine learning model that achieves high performance while maintaining data privacy.

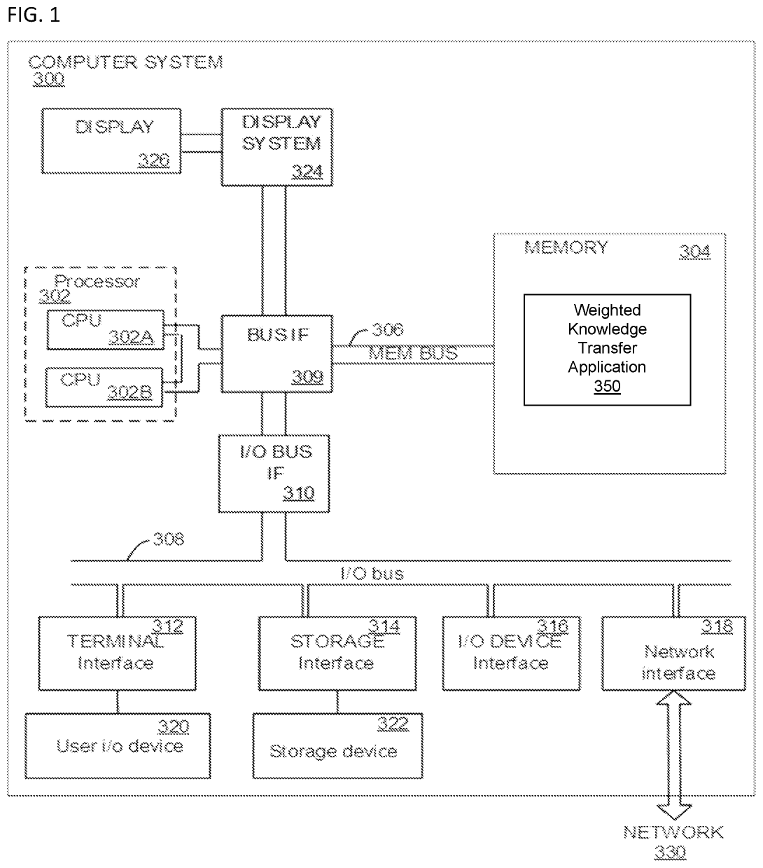

Turning now to the Figures, FIG. 1 depicts a high-level block diagram of a computer system 300 for implementing various embodiments of the present disclosure, according to embodiments. The mechanisms and apparatus of the various embodiments disclosed herein apply equally to any appropriate computing system. The major components of the computer system 300 include one or more processors 302, a memory 304, a terminal interface 312, a storage interface 314, an I/O (Input/Output) device interface 316, and a network interface 318, all of which are communicatively coupled, directly or indirectly, for inter-component communication via a memory bus 306, an I/O bus 308, bus interface unit 309, and an I/O bus interface unit 310.

The computer system 300 may contain one or more general-purpose programmable central processing units (CPUs) 302A and 302B, herein generically referred to as the processor 302. In embodiments, the computer system 300 may contain multiple processors; however, in certain embodiments, the computer system 300 may alternatively be a single CPU system. Each processor 302 executes instructions stored in the memory 304 and may include one or more levels of on-board cache.

In embodiments, the memory 304 may include a random-access semiconductor memory, storage device, or storage medium (either volatile or non-volatile) for storing or encoding data and programs. In certain embodiments, the memory 304 represents the entire virtual memory of the computer system 300, and may also include the virtual memory of other computer systems coupled to the computer system 300 or connected via a network. The memory 304 can be conceptually viewed as a single monolithic entity, but in other embodiments the memory 304 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 304 may store all or a portion of the various programs, modules and data structures for processing data transfers as discussed herein. For instance, the memory 304 can store a weighted knowledge transfer application 350. In embodiments, the weighted knowledge transfer application 350 may include instructions or statements that execute on the processor 302 or instructions or statements that are interpreted by instructions or statements that execute on the processor 302 to carry out the functions as further described below.

In certain embodiments, the weighted knowledge transfer application 350 is implemented in hardware via semiconductor devices, chips, logical gates, circuits, circuit cards, and/or other physical hardware devices in lieu of, or in addition to, a processor-based system. In embodiments, the weighted knowledge transfer application 350 may include data in addition to instructions or statements. In certain embodiments, a camera, sensor, or other data input device (not shown) may be provided in direct communication with the bus interface unit 309, the processor 302, or other hardware of the computer system 300. In such a configuration, the need for the processor 302 to access the memory 304 and the latent factor identification application may be reduced.

The computer system 300 may include a bus interface unit 309 to handle communications among the processor 302, the memory 304, a display system 324, and the I/O bus interface unit 310. The I/O bus interface unit 310 may be coupled with the I/O bus 308 for transferring data to and from the various I/O units. The I/O bus interface unit 310 communicates with multiple I/O interface units 312, 314, 316, and 318, which are also known as I/O processors (IOPs) or I/O adapters (IOAs), through the I/O bus 308. The display system 324 may include a display controller, a display memory, or both. The display controller may provide video, audio, or both types of data to a display device 326. Further, the computer system 300 may include one or more sensors or other devices configured to collect and provide data to the processor 302.

As examples, the computer system 300 may include biometric sensors (e.g., to collect heart rate data, stress level data), environmental sensors (e.g., to collect humidity data, temperature data, pressure data), motion sensors (e.g., to collect acceleration data, movement data), or the like. Other types of sensors are also possible. The display memory may be a dedicated memory for buffering video data. The display system 324 may be coupled with a display device 326, such as a standalone display screen, computer monitor, television, or a tablet or handheld device display.

In one embodiment, the display device 326 may include one or more speakers for rendering audio. Alternatively, one or more speakers for rendering audio may be coupled with an I/O interface unit. In alternate embodiments, one or more of the functions provided by the display system 324 may be on board an integrated circuit that also includes the processor 302. In addition, one or more of the functions provided by the bus interface unit 309 may be on board an integrated circuit that also includes the processor 302.

The I/O interface units support communication with a variety of storage and I/O devices. For example, the terminal interface unit 312 supports the attachment of one or more user I/O devices 320, which may include user output devices (such as a video display device, speaker, and/or television set) and user input devices (such as a keyboard, mouse, keypad, touchpad, trackball, buttons, light pen, or other pointing device). Auser may manipulate the user input devices using a user interface in order to provide input data and commands to the user I/O device 320 and the computer system 300, and may receive output data via the user output devices. For example, a user interface may be presented via the user I/O device 320, such as displayed on a display device, played via a speaker, or printed via a printer.

The storage interface 314 supports the attachment of one or more disk drives or direct access storage devices 322 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 322 may be implemented via any type of secondary storage device. The contents of the memory 304, or any portion thereof, may be stored to and retrieved from the storage device 322 as needed. The I/O device interface 316 provides an interface to any of various other I/O devices or devices of other types, such as printers or fax machines. The network interface 318 provides one or more communication paths from the computer system 300 to other digital devices and computer systems; these communication paths may include, for example, one or more networks 330.

Although the computer system 300 shown in FIG. 1 illustrates a particular bus structure providing a direct communication path among the processors 302, the memory 304, the bus interface 309, the display system 324, and the I/O bus interface unit 310, in alternative embodiments the computer system 300 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 310 and the I/O bus 308 are shown as single respective units, the computer system 300 may, in fact, contain multiple I/O bus interface units 310 and/or multiple I/O buses 308. While multiple I/O interface units are shown which separate the I/O bus 308 from various communications paths running to the various I/O devices, in other embodiments, some or all of the I/O devices are connected directly to one or more system I/O buses.

In various embodiments, the computer system 300 is a multi-user mainframe computer system, a single-user system, or a server computer or similar device that has little or no direct user interface, but receives requests from other computer systems (clients). In other embodiments, the computer system 300 may be implemented as a desktop computer, portable computer, laptop or notebook computer, tablet computer, pocket computer, telephone, smart phone, or any other suitable type of electronic device.

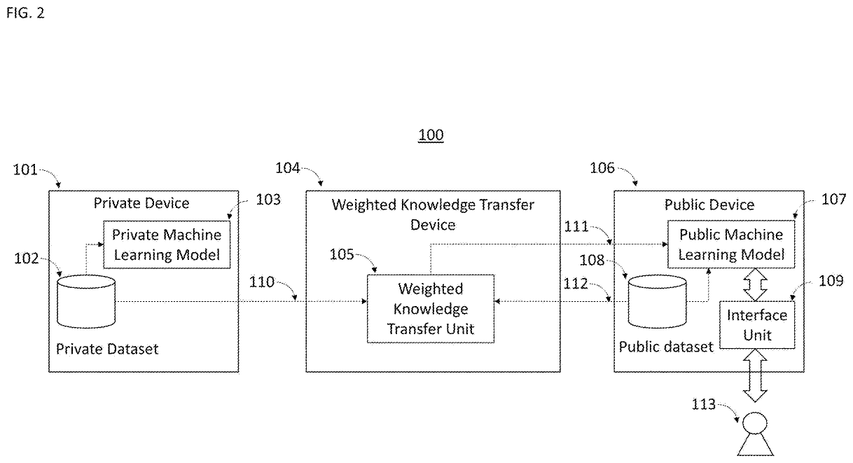

Next, an example configuration of a weighted knowledge transfer system according to embodiments of the present disclosure will be described with reference to FIG. 2.

FIG. 2 illustrates an example configuration of a weighted knowledge transfer system 100, according to embodiments. As illustrated in FIG. 2, the weighted knowledge transfer system 100 primarily includes a private device 101, a weighted knowledge transfer device 104, and a public device 106. The private device 101, the weighted knowledge transfer device 104, and the public device 106 may be communicably connected via a communication network such as a local area network (LAN) or the Internet.

The private device 101 is a storage device configured to store a private dataset 102 and a private machine learning model 103 trained on the private dataset 102. For example, the private device 101 may include a collection of hard disk drives, solid state drives, or cloud-based storage repositories configured to store the private dataset 102 and the private machine learning model 103.

The private dataset 102 may include a collection of data that contains confidential information. For example, the private dataset 102 may include information regarding medical records, financial transactions, or personal data (names, addresses, passwords, bank account information) for one or more individuals, businesses, or other organizations.

The private machine learning model 103 may include a machine learning model that has been trained using the private dataset 102. For example, the machine learning model may be a neural network that has been trained to predict health risks for patients based on the private dataset 102.

The private device 101 may be maintained in a private network of an individual, business, or other organization. For example, the private device 101 may belong to a hospital. In embodiments, the private device 101 may be connected to a weighted knowledge transfer device 104 via interface 110. The private device 101 may be insulated from the public device 106 by the weighted knowledge transfer device 104 (that is, the private device 101 may be inaccessible from the public device 106). Accordingly, users 113 accessing the public machine learning model 107 through the interface unit 109 of the public device 106 cannot retrieve the private dataset 102 through malicious acts (e.g., hacking) because the public machine learning model 107 has been trained solely using the public dataset 108.

The public device 106 is a storage device configured to store a public dataset 108 and a public machine learning model 107 trained on the public dataset 102. For example, the public device 106 may include a collection of hard disk drives, solid state drives, or cloud-based storage repositories configured to store the private dataset 108 and the public machine learning model 107.

The public dataset 108 may include a collection of data that contains public information. For example, the public dataset 108 may include information regarding medical records or financial transactions that are not associated with any particular individual or entity.

The public machine learning model 107 may include a machine learning model that has been created using the weighted knowledge transfer unit 105 based on the public dataset 108 and the private dataset 102. For example, the machine learning model may be a neural network that has been trained to predict the occurrence of health risks based on the presence of particular health factors included in the public dataset 108.

In embodiments, the public machine learning model 107 may be accessible to users 113 via an interface unit 109. For example, the interface unit 109 may include a server module configured to provide access to the public machine learning model 107 as a service (e.g., via a subscription-based software application or the like). Users may access the public machine learning model 107 via the interface unit 109 to obtain insights provided by the public machine learning model 107.

The weighted knowledge transfer device 104 is a storage device configured to store one or more functional units used to perform the weighted knowledge transfer process according to the present disclosure. As illustrated in FIG. 2, the weighted knowledge transfer device 104 may include a weighted knowledge transfer unit 105. The weighted knowledge transfer unit 105 is a functional unit configured to perform a weighted knowledge transfer from the private machine learning model 103 to the public machine learning model 107 in order to create a privacy preserving public machine learning model that achieves high performance while maintaining data privacy.

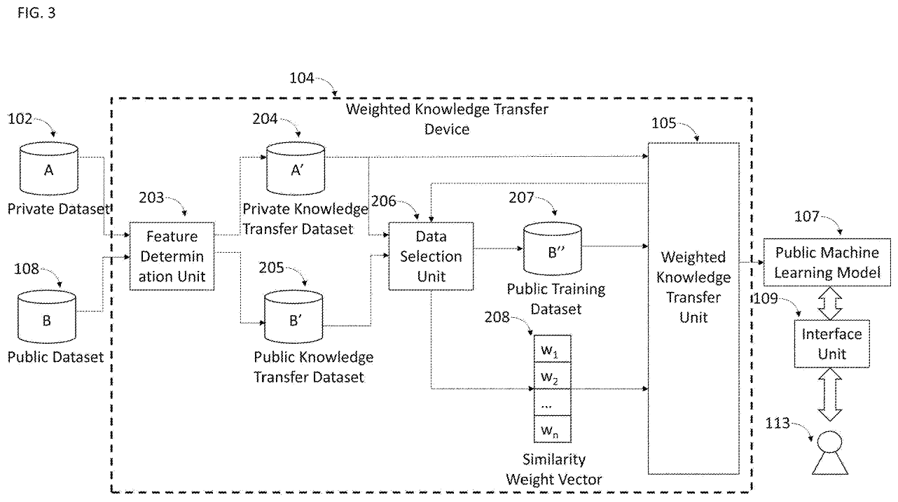

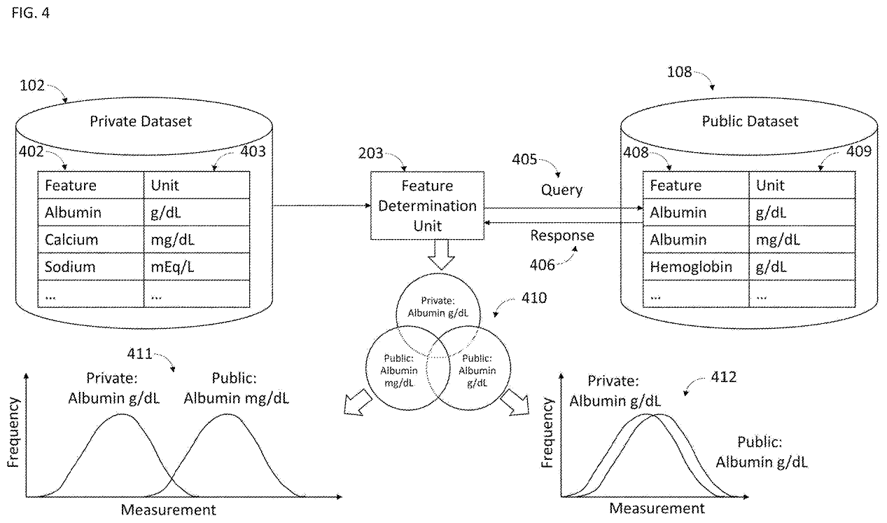

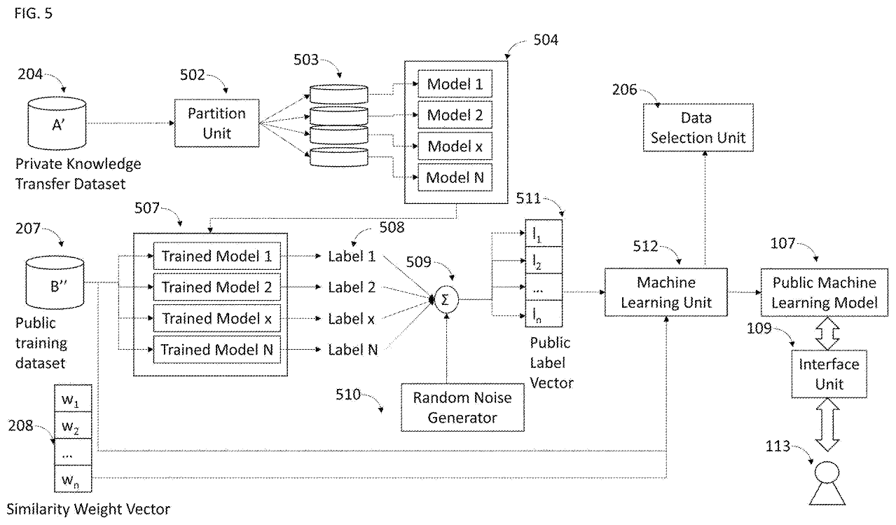

It should be noted that FIG. 2 illustrates a simplified configuration of the weighted knowledge transfer system 100, and the weighted knowledge transfer system 100 is not limited to the configuration illustrated in FIG. 2. For instance, in addition to the weighted knowledge transfer unit 105, the weighted knowledge transfer device 104 may include a feature determination unit, a data selection unit, a partition unit, and a random noise generator as illustrated in FIG. 3, FIG. 4, and FIG. 5.

The weighted knowledge transfer unit 105 may access the private dataset 102 through an interface 110, and access the public dataset 108 through an interface 112 to create the public machine learning model 107 through the interface 111. As the details of the weighted knowledge transfer unit 105 will be described later, the description thereof will be omitted here.

The weighted knowledge transfer system 100 according to the present disclosure may be applied to a variety of domains. Below, an example will be considered in which the weighted knowledge transfer system 100 is applied to a healthcare domain.

In embodiments, the private device 101 may be a server deployed within a private network managed by a healthcare facility (e.g., an entity subject to the Health Insurance Portability and Accountability Act). The private dataset 102 may include electronic health records of patients in the care of the healthcare facility. These electronic health records may contain personal information that should not be accessible to unauthorized entities or shared without the consent of the patients. The private machine learning model 103 may be trained to predict risks such as hospital readmission risks or mortality risks based on the private data set 102. The predictions made by the private machine learning model 103 may be used by healthcare professionals to take appropriate actions to improve the well-being of patients.

In this case, the weighted knowledge transfer unit 105 stored on the weighted knowledge transfer device 104 may access the private dataset 102 containing the electronic health records via the interface 110, and access a public dataset 108 containing publicly available healthcare information (e.g., a Medical Information Mart for Intensive Care dataset) via the interface 112. As will be described later, the weighted knowledge transfer unit 105 uses the public dataset 108 and the private dataset 102 to generate the public machine learning model 107. As described herein, the public machine learning model 107 has comparable performance to the private machine learning model 103, but is trained on the public dataset 108 such that sensitive information present in the private dataset 102 is not accessible to unauthorized users even in the event of a cyberattack.

The weighted knowledge transfer system 100 illustrated in FIG. 2 makes it possible to perform a weighted knowledge transfer from a private machine learning model to a public machine learning model in order to create a privacy preserving public machine learning model that achieves high performance while maintaining data privacy. The weighted knowledge transfer system 100 may provide benefits associated with data privacy and machine learning model performance.

Next, an example logical configuration of the weighted knowledge transfer device will be described with reference to FIG. 3.

FIG. 3 illustrates an example logical configuration of a weighted knowledge transfer device 104, according to embodiments. The weighted knowledge transfer device 104 may be used to generate a privacy preserving public machine learning model that achieves high performance while maintaining data privacy by performing a weighted knowledge transfer from a private machine learning model to a public machine learning model.

First, feature determination unit 203 analyzes the private dataset 102 and the public dataset 108 to determine a set of target features. The set of target features may include a collection of features that are shared between the private dataset 102 and the public dataset 108. In embodiments, the feature determination unit 203 may determine the set of target features by using one or more of a variety of statistical analysis techniques with respect to the private data to ascertain features that are shared between the private dataset 102 and the public dataset 108. In embodiments, the feature determination unit 203 may determine the set of target features by using natural language processing based methods.

Subsequently, the feature determination unit 203 may output a private knowledge transfer dataset 204 and a public knowledge transfer dataset 205 that both include the set of target features. The private knowledge transfer dataset 204 and the public knowledge transfer dataset 205 are subsets of the private dataset 102 and the public dataset 108, respectively, that both contain the set of target features determined by the feature determination unit.

Next, data selection unit 206 inputs the private knowledge transfer dataset 204 and the public knowledge transfer dataset 205, and generates, based on a similarity calculation of the private knowledge transfer dataset 204 and the public knowledge transfer dataset 205, a public training dataset 207 which is a subset of the public knowledge transfer dataset 205 that achieves a similarity threshold with respect to the private knowledge transfer dataset 204, and a similarity weight vector 208 that indicates weights of a set of public features included in the public training dataset 207.

In order to facilitate an efficient knowledge transfer it is desirable for the feature space coverage of the public knowledge transfer dataset 205 to be substantially equivalent to the feature space of the private knowledge transfer dataset 204. Accordingly, for the feature space A and B′ of the private knowledge transfer dataset 204 and the public knowledge transfer dataset 205, respectively, the data selection unit 206 generates a public training dataset 207 that approximates the feature space coverage of the private knowledge transfer dataset 204.

As described herein, in embodiments, the data selection unit 206 may generate the public training dataset 207 and the similarity weight vector 208 based on a similarity calculation of the private knowledge transfer dataset 204 and the public knowledge transfer dataset 205. For example, the data selection unit 206 may calculate the similarity of each feature in the public knowledge transfer dataset 205 with respect to each feature in the private knowledge transfer dataset 204. Here, the similarity may be calculated using a distance calculation including the Euclidean, Manhattan, Chebyshev, or Mahalanobis methods. Each feature in the public knowledge transfer dataset 205 may be annotated with a calculated similarity score which can be normalized to fall within the range of 0 to 1. These scores are then attached to each feature in the public knowledge transfer dataset 205 and output as the weight vector 208. Based on a threshold which can either be set by the user or determined in a feedback loop from the weighted knowledge transfer unit 209, the set of features (e.g., the set of public features) to be included in the public training dataset 207 may be determined.

In embodiments, the similarity between the private knowledge transfer dataset 204 and the public knowledge transfer dataset 205 may be determined by statistical methods such as propensity scoring matching methods and clustering methods such as k-means clustering. Further, in embodiments, the similarity between the private knowledge transfer dataset 204 and the public knowledge transfer dataset 205 may be determined with information theoretic means such as the Kullback-Leibler divergence method or various measures of entropy.

In embodiments, the similarity between the private knowledge transfer dataset 204 and the public knowledge transfer dataset 205 may be determined using machine learning model-based similarity. As an example, a new private machine learning model may be created using the private knowledge transfer unit 204. This newly created machine learning model may be used to perform a particular prediction task (e.g., classifying patients into various risk groups). The machine learning model may calculate the probability of a particular set of features (e.g., patient) based on data from the private knowledge transfer dataset 204, assign a probability of the set of features belonging to each of a number of groups, and choose the final group label based on a statistical decision-making method.

The trained private machine learning models created using the private knowledge transfer dataset 204 implicitly contains knowledge about the private knowledge transfer dataset 204 which is encoded in the model structure, such as the internal weights of a neural network or the node parameters of a decision tree model. This knowledge is used to measure the similarity of features in the public knowledge transfer dataset 205 by instructing the trained private machine learning model to make predictions using those features. Each set of features in the public knowledge transfer dataset 205 may be assigned a probability of belonging to each group of a set of groups. Based on these output probabilities the similarity of a sample in the public knowledge transfer dataset 205 to the private knowledge transfer dataset 204 can be inferred with statistical decision-making methods such as measuring the entropy of the output probability distribution and categorizing low entropy samples to be similar to the private knowledge transfer dataset 204 whereas high entropy samples are categorized as dissimilar to the private knowledge transfer dataset 204. As described herein, the entropy measures can be normalized to a range of 0 to 1 and converted to a weight vector 208 that is output by the data selection unit 206.

In embodiments, the similarity between the private knowledge transfer dataset 204 and the public knowledge transfer dataset 205 may be determined by labeling sets of features in the private knowledge transfer dataset 204 as belonging to the private knowledge transfer dataset 204, and labeling sets of features in the public knowledge transfer dataset 205 as belonging to the public knowledge transfer dataset 205. Subsequently, the private knowledge transfer dataset 204 and the public knowledge transfer dataset 205 may be merged into a single dataset, and a discriminator model may be used to distinguish the data by calculating the likelihood of a particular set of features to either belong to the private knowledge transfer dataset 204 or the public knowledge transfer dataset 205.

Once the discriminator model has been trained, the trained discriminator model may be used to process the public knowledge transfer dataset 205 and output for each set of features a probability of this set of features belonging to the private knowledge transfer dataset 204. Sets of features with a probability that achieves a probability threshold may be selected for inclusion in the public training dataset 207. The calculated probabilities may be output as the weight vector 208 by the data selection unit 206. Here, the probability threshold can either be set by a user or determined in a feedback loop from the weighted knowledge transfer unit 209.

Further, in embodiments, the data selection unit 206 may generate the public training dataset 207 and the similarity weight vector 208 using techniques such as generative adversarial networks. A generator network may be trained to generate sets of generated features similar to the features of the private knowledge transfer dataset 204. A discriminator network may be trained to distinguish between the sets of generated features and a set of private features included in the private knowledge transfer dataset 204 (e.g., real features). After training, the discriminator network may be used to evaluate the set of generated features generated by the trained generator network to calculate a probability of a set of generated features belonging to the private knowledge transfer dataset 204. Subsequently, the discriminator network may select, as the public training dataset 207, a subset of the set of generated features that are associated with a probability of belonging to the private knowledge transfer dataset 204 that exceeds a first probability threshold. The calculated probabilities may be output as the weight vector 208 by the data selection unit 206.

The weighted knowledge transfer unit 105 may use the private knowledge transfer dataset 204, the public knowledge transfer dataset 205, the public training dataset 207, and the weight vector 208 to create a public machine learning model 107. As described herein, access to the public machine learning model 107 may be provided to users 113 via the interface unit 109. As the details of the weighted knowledge transfer unit 105 will be described later, the description thereof will be omitted here.

Next, an example of selecting a set of target features for use in creation of the privacy preserving public machine learning model will be described with reference to FIG. 4.

FIG. 4 illustrates an example of selecting a set of target features for use in creation of the privacy preserving public machine learning model, according to embodiments. As described herein, the feature determination unit 203 according to the present disclosure analyzes the private dataset 102 and the public dataset 108 to determine a set of target features that are shared between the private dataset 102 and the public dataset 108. Subsequently, the feature determination unit 203 may output a private knowledge transfer dataset 204 and a public knowledge transfer dataset 205 that both include the set of target features.

Below, an example of determining the set of target features for outputting the private knowledge transfer dataset 204 and the public knowledge transfer dataset 205 will be described in the context of a healthcare application.

In embodiments, as illustrated in FIG. 4, the private dataset 102 may include a description table that lists a set of private features 402 and their respective units of measurement 403 (e.g., information available in the electronic health records of a healthcare system). Similarly, the public dataset 108 may include a description table that lists a set of public features 408 and their respective units of measurement 409. In embodiments, the feature extraction unit 203 may be configured to generate these description tables from unstructured data included in the private dataset 102 and the public dataset 108 respectively to facilitate feature determination.

For each feature of the set of private features 402 in the data description table of the private dataset 102, the feature determination unit 203 may transmit a query 405 to ascertain the presence or absence of this feature in the set of public features 408 in the description table of the public dataset 108, and subsequently receive a response 406 indicating the presence or absence of this feature in the set of public features 408 in the description table of the public dataset 108. Here, the comparison between the set of private features 402 and the set of public features 408 may be performed using a natural language processing unit to parse the semantic or syntactic similarity between particular features.

In the example illustrated in FIG. 4, for example, the set of private features 402 may include a feature of “albumin” that is measured in units of “g/dL”. The feature determination unit 203 may determine based on the response 406 that the feature of “albumin” is available in the set of public features 408, but depending on the record is measured in difference scales of “g/dL” and “mg/dL.” In embodiments, the feature determination unit 203 may determine that the feature of “albumin” in the set of public features 408 that is measured in units of “g/dL” achieves a higher similarity with respect to the feature of “albumin” in the set of private features 402 that is measured in units of “g/dL,” and determine this feature of “albumin” that is measured in units of “g/dL” as a target feature that can be used in the knowledge transfer process.

In the case that units of measurement cannot be found for the features stored in the data description tables, statistical methods based on distance or similarity measures may be used to determine if a feature available in both the private dataset 102 and the public dataset 108 can be used in the knowledge transfer process. As an example, the feature determination unit 203 may acquire probability density functions 410 for a particular feature (e.g., “albumin”) based on measurement frequency counts in the public dataset 108 and the private dataset 102.

Subsequently, the feature determination unit 203 may use a determination threshold based on the Kullback-Leibler divergence, for instance, to determine if the particular feature is measured on the same scale in both the private dataset 102 and the public dataset 108. For instance, in the case that the distributions do not satisfy the determination threshold, as illustrated in graph 411, the feature determination unit 203 may determine that the particular feature is measured on different scales between the private dataset 102 and the public dataset 108, and exclude it as a target feature. In contrast, in the case that the distributions satisfy the determination threshold, as illustrated in graph 412, the feature determination unit 203 may determine that the particular feature is measured on the same scale between the private dataset 102 and the public dataset 108, and include it as a target feature. In certain embodiments, the feature determination unit 203 may be configured to perform unit conversions on particular features to facilitate comparison of the set of private features 402 and the set of public features 408.

In this way, a set of target features for use in creation of the privacy preserving public machine learning model can be determined.

Next, an example logical configuration of a weighted knowledge transfer unit for creating the privacy preserving public machine learning model will be described with reference to FIG. 5.

FIG. 5 illustrates an example logical configuration of a weighted knowledge transfer unit for creating the privacy preserving public machine learning model, according to embodiments. As described herein, the weighted knowledge transfer unit uses the private knowledge transfer dataset 204, the public training dataset 207, and the weight vector 208 as inputs to generate a privacy preserving public machine learning model 107 that can be accessed by users 113 via an interface unit 109.

Partition unit 502 divides the private knowledge transfer dataset 204 into a plurality of partitions 503. Here, a partition refers to a portion of the private knowledge transfer dataset that includes a mutually exclusive set of private features with respect to the other partitions of the plurality of partitions 503. In this way, data corresponding to one set of features (e.g., one patient in a healthcare context) is not distributed among multiple partitions but randomly assigned and maintained exclusively in one partition.

Next, machine learning model management unit 504 trains a set of machine learning models using the plurality of partitions 503 in order to generate a set of trained private machine learning models 507. In embodiments, the machine learning model management unit 504 trains each of the set of machine learning models based on a separate portion of the plurality of partitions 503, such that no data from other partitions is used. In this way, the performance of each machine learning model is optimized using only the data included in one partition of the plurality of partitions 503.

Next, machine learning model management unit 504 generates, by processing the public training dataset 207 with the set of trained private machine learning models 507, a public label vector 511 that indicates labels for the set of public features included in the public training dataset 207. More particularly, the machine learning model management unit 504 receives the public knowledge transfer dataset 207 as input, and uses the set of trained private machine learning models 507 to perform a machine learning task (e.g., a prediction task, a classification task, a detection task) on each set of features in the public training dataset 207. As an example, in a healthcare context, the machine learning model management unit 504 may use the set of trained private machine learning models 507 to predict a risk group label for each set of features (e.g., patient) included in the public training dataset 207. For each of a set of possible output labels, each of the set of trained private machine learning models 507 assigns a probability to each label for each set of features in the public training dataset 207. Next, using a statistical decision-making method such as maximum likelihood, each trained machine learning model assigns a label to each set of features.

As each of the sets of features in the public training dataset 207 are processed by each trained machine learning model of the set of trained private machine learning models 507, each set of features is assigned a plurality of labels 508. Accordingly, the machine learning model management unit 504 aggregates the label counts for each set of features and adds random noise from a random noise generator 510. Next, the machine learning model management unit 504 selects the label having the majority of counts as the final output label for this set of features of the public training dataset 207. The addition of random noise reduces the likelihood of a tie in which multiple candidate labels have the same count number. However, in the event of a tie in which multiple candidate labels have the same count number, a label may be chosen at random as the final output label. By performing this labeling process for each set of features in the public training dataset 207, the machine learning model management unit 504 can generate the public label vector 511 that indicates labels for each of the set of public features included in the public training dataset 207.

Next, the machine learning unit 512 uses the public training dataset 207, the similarity weight vector 208, and the public label vector 511 to create and train the public machine learning model 107. As described herein, the public machine learning model 107 has comparable performance to a private machine learning model trained on private datasets, but is trained on the public training dataset 207 such that sensitive information present in the private datasets is not accessible to unauthorized users even in the event of a cyberattack.

In embodiments, the machine learning unit 512 may utilize a mapping function that adjusts the priority of sets of features in the public training dataset 207 based on their corresponding weights in the similarity weight vector 208. For instance, the public machine learning model 107 being trained by the machine learning unit 512 may use the sets of features in the public training dataset 207 as input and the labels in the public label vector 511 as the prediction target. The performance of the public machine learning model 107 is optimized by minimizing a loss function. Further, as part of the training process, the weights of the sets of features of the public training dataset 207 in the similarity weight vector 208 may be adjusted through a feedback loop between the machine learning unit 512 and the data selection unit 206.

Upon completion of the training process, the public machine learning model 107 created by the machine learning unit 512 may be made publicly accessible as a service to users 113 via an interface unit 109.

The weighted knowledge transfer unit configuration illustrated in FIG. 5 makes it possible to perform a weighted knowledge transfer from a private machine learning model to a public machine learning model in order to create a privacy preserving public machine learning model that achieves high performance while maintaining data privacy. The weighted knowledge transfer configuration illustrated in FIG. 5 may provide benefits associated with data privacy and machine learning model performance.

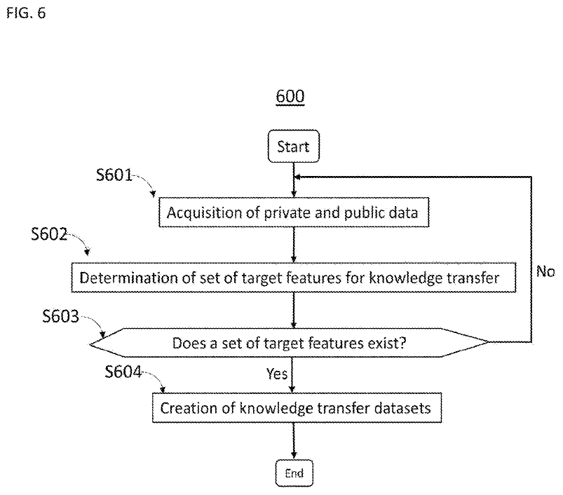

Next, the knowledge transfer dataset creation process according to the present disclosure will be described with reference to FIG. 6.

FIG. 6 illustrates a flowchart of a knowledge transfer dataset creation process 600, according to embodiments. The knowledge transfer dataset creation process 600 is a process for creating the knowledge transfer datasets (e.g., the private knowledge transfer dataset 204 and the public knowledge transfer dataset 205 illustrated in FIG. 3) according to the present disclosure, and may be performed by the feature determination unit (for example, the feature determination unit 203 illustrated in FIG. 3).

First, at Step S601, the feature determination unit acquires a private dataset and a public dataset. In embodiments, the feature determination unit may acquire the private dataset by requesting access to it via a secure connection between the weighted knowledge transfer device and a private device (e.g., owned by a hospital, business, individual, or other organization). In embodiments, the feature determination unit may acquire the public dataset by accessing a public data repository. In certain embodiments, the private dataset and the public dataset may be selected by an administrator of the weighted knowledge transfer device.

Next, at Step S602, the feature determination unit determines a set of target features by analyzing the private dataset and the public dataset. As described herein, the set of target features may include a collection of features that are shared between the private dataset and the public dataset. In embodiments, the feature determination unit may determine the set of target features by using one or more of a variety of statistical analysis techniques with respect to the private data to ascertain features that are shared between the private dataset and the public dataset. Further, in embodiments, the feature determination unit 203 may determine the set of target features by using natural language processing based methods.

Next, at Step S603, in the case that the feature determination unit was able to determine a set of target features (e.g., a set of shared features was present in both the public dataset and the private dataset), the knowledge transfer dataset creation process 600 proceeds to Step S604. In contrast, in the case that the feature determination unit was not able to determine a set of target features (e.g., a set of shared features was not present in both the public dataset and the private dataset), the knowledge transfer dataset creation process 600 returns to Step S601 to acquire different or additional private and public data.

Next, at Step S604, the feature determination unit may create a private knowledge transfer dataset and a public knowledge transfer dataset that both include the set of target features. For instance, the feature determination unit may extract a set of public features from the public dataset as the public knowledge transfer dataset and extract a set of private features from the public dataset as the private knowledge transfer dataset, where the set of public features and the set of private features substantially correspond to one another.

As described herein, the knowledge transfer dataset creation process 600 described above with reference to FIG. 6 allows for the creation of knowledge transfer datasets to be used in the weighted knowledge transfer process.

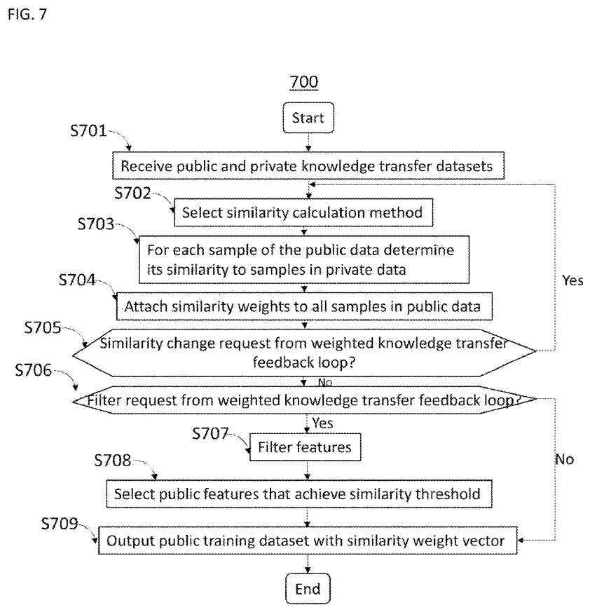

Next, a similarity weighting process according to the present disclosure will be described with reference to FIG. 7.

FIG. 7 illustrates a flowchart of a similarity weighting process 700, according to embodiments. The similarity weighting process 700 is a process for generating a similarity weighting vector (for example, the similarity weighting vector 208 illustrated in FIG. 3) for a set of public features included in a public training dataset, and may be performed by the data selection unit (for example, the data selection unit 206 illustrated in FIG. 3).

First, at Step S701, the data selection unit receives the private knowledge transfer dataset and the public knowledge transfer dataset. Here, the data selection unit may receive transmission of the private knowledge transfer dataset and the public knowledge transfer dataset from the feature extraction unit, or may access a designated storage address where the private knowledge transfer dataset and the public knowledge transfer dataset have been stored.

Next, at Step S702, the data selection unit determines a similarity calculation method for calculating the degree of similarity between the public knowledge transfer dataset and the private knowledge transfer dataset. As described herein, the similarity calculation may be selected from a variety of similarity calculation techniques including Euclidean, Manhattan, Chebyshev, or Mahalanobis distance calculations, statistical methods such as propensity scoring matching methods and clustering methods such as k-means clustering machine learning, model-based similarity, discriminator networks, generative adversarial networks, or the like. In embodiments, the data selection unit may determine the similarity calculation method by using a machine learning model trained to predict which of a number of given similarity calculation techniques is most likely to achieve the highest accuracy with respect to the nature of the public knowledge transfer dataset and the private knowledge transfer dataset. In embodiments, the data selection unit may determine the similarity calculation method based using a lookup table that ranks the performance of each of a number of given similarity calculation techniques based on the nature of the public knowledge transfer dataset and the private knowledge transfer dataset.

Next, at Step S703, the data selection unit utilizes the similarity calculation method determined in Step S702 to calculate the similarity of each feature in the public knowledge transfer dataset with respect to each feature in the private knowledge transfer dataset. In embodiments, the calculated similarity may be expressed as a similarity weight value between 0 and 1, where greater values indicate a higher degree of similarity.

Next, at Step S704, the data selection unit attaches the similarity weight values calculated in Step S703 to the corresponding features in the public knowledge transfer dataset.

Next, at Step S705, the data selection unit may confirm whether or not a similarity change request has been received from the machine learning unit as part of the feedback loop of training the public machine learning model. The similarity change request, may, for example, be a request from the machine learning unit to increase or decrease the similarity weight of a particular feature or type of feature of the set of public features of the public knowledge transfer dataset. In the case that a similarity change request has been received, the similarity weighting process 700 may return to Step S702. In the case that a similarity change request has not been received, the similarity weighting process 700 may proceed to Step S706.

Next, at Step S706, the data selection unit may confirm whether or not a filter request has been received from the machine learning unit as part of the feedback loop of training the public machine learning model. The filter request may, for example, be a request from the machine learning unit to delete or exclude a particular feature or type of feature from the set of public features of the public knowledge transfer dataset. In the case that a filter request has been received, the similarity weighting process 700 may proceed to Step S707. In the case that a filter change request has not been received, the similarity weighting process 700 may proceed to Step S709.

Next, at Step S707, the data selection unit may filter the set of public features included in the public knowledge transfer dataset based on the filter request received at Step S706. For example, the data selection unit may delete, from the set of public features, those features specified in the filter request received at Step S706.

Next, at Step S708, the data selection unit may select, from the set of public features included in the public knowledge transfer dataset, those public features that are associated with a similarity weight above a similarity threshold as the public training dataset. Here, the similarity threshold can either be set by the user or determined in a feedback loop from the weighted knowledge transfer unit.

Next, at Step S709, the data selection unit may output the public training dataset selected in Step S708 together with a similarity weight vector indicating the weights of the set of public features included in the public training dataset. In embodiments, the data selection unit may output the public training dataset and the similarity weight vector to the weighted knowledge transfer unit (for example, the weighted knowledge transfer unit 105 illustrated in FIG. 3). As described herein, the weighted knowledge transfer unit may use the private knowledge transfer dataset, the public knowledge transfer dataset, the public training dataset, and the weight vector to create a public machine learning model.

As described herein, the similarity weighting process 700 described above with reference to FIG. 7 allows for the creation of the public training dataset and the weight vector used to create the public machine learning model.

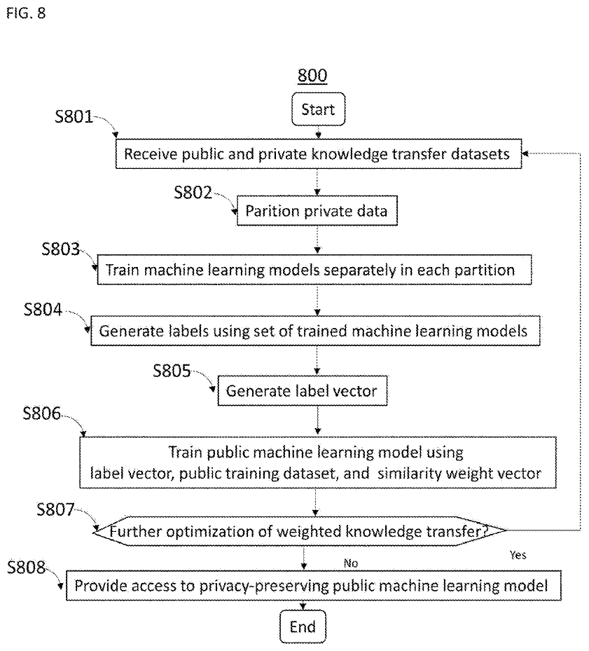

Next, a weighted knowledge transfer process according to the present disclosure will be described with reference to FIG. 8.

FIG. 8 illustrates a flowchart of a weighted knowledge transfer process 800, according to embodiments. The weighted knowledge transfer process 800 is a process for training a public machine learning model (for example, the public machine learning model 107 illustrated in FIG. 3) that achieves comparable performance to a private machine learning model, and may be performed by the weighted knowledge transfer unit (for example, the weighted knowledge transfer unit 105 illustrated in FIG. 3).

First, at Step S801, the weighted knowledge transfer unit acquires the private knowledge transfer dataset and the public knowledge transfer dataset. Here, the weighted knowledge transfer unit may receive transmission of the private knowledge transfer dataset and the public knowledge transfer dataset from the feature extraction unit, or may access a designated storage address where the private knowledge transfer dataset and the public knowledge transfer dataset have been stored.

Next, at Step S802, the weighted knowledge transfer unit may divide the private knowledge transfer dataset into a plurality of partitions. As described herein, here, a partition refers to a portion of the private knowledge transfer dataset that includes a mutually exclusive set of private features with respect to the other partitions of the plurality of partitions 503. In this way, data corresponding to one set of features (e.g., one patient in a healthcare context) is not distributed among multiple partitions but randomly assigned and maintained exclusively in one partition.

Next, at Step S803, the weighted knowledge transfer unit trains a set of machine learning models using the plurality of partitions in order to generate a set of trained private machine learning models. In embodiments, the weighted knowledge transfer unit trains each of the set of machine learning models based on a separate portion of the plurality of partitions, such that no data from other partitions is used. In this way, the performance of each machine learning model is optimized using only the data included in one partition of the plurality of partitions.

Next, at Step S804, the weighted knowledge transfer unit generates, by processing the public training dataset knowledge transfer dataset with the set of trained private machine learning models trained in Step S803, a set of labels for the set of public features included in the public training dataset.

Next, at Step S805, the weighted knowledge transfer unit generates the public label vector by aggregating the set of labels generated in Step S804 for each set of features, adding random noise from a random noise generator, and selecting the label that has the majority of counts as the final output label for each set of features of the public training dataset.

Next, at Step S806, the weighted knowledge transfer unit uses the public training dataset, the similarity weight vector, and the public label vector generated in Step S805 to create and train the public machine learning model. As described herein, the public machine learning model has comparable performance to a private machine learning model trained on private datasets, but is trained on the public training dataset such that sensitive information present in the private datasets is not accessible to unauthorized users even in the event of a cyberattack.

Next, at Step S807, the weighted knowledge transfer unit confirms whether or not there is a request for further optimization of the weighted knowledge transfer. For example, the weighted knowledge transfer unit may verify whether or not there is feedback from previously performed weighted knowledge transfer processes that may be used to further optimize the current weighted knowledge transfer. As another example, the weighted knowledge transfer unit may prompt a user for additional instructions or data that may be used to further optimize the weighted knowledge transfer. In the case that the weighted knowledge transfer unit determines that further optimization is possible, the weighted knowledge transfer process 800 returns to Step S801. In the case that the weighted knowledge transfer unit determines that further optimization is not possible, the weighted knowledge transfer process 800 proceeds to Step S808.

Next, at Step S808, the weighted knowledge transfer unit may provide access to the public machine learning model trained in Step S806. For example, as described herein, the weighted knowledge transfer unit may configure the public machine learning model to be accessed by users as a network-based service via an interface unit (e.g., software application).

The weighted knowledge transfer process 800 illustrated in FIG. 8 makes it possible to perform a weighted knowledge transfer from a private machine learning model to a public machine learning model in order to create a privacy preserving public machine learning model that achieves high performance while maintaining data privacy. The weighted knowledge transfer process 800 illustrated in FIG. 8 may provide benefits associated with data privacy and machine learning model performance.

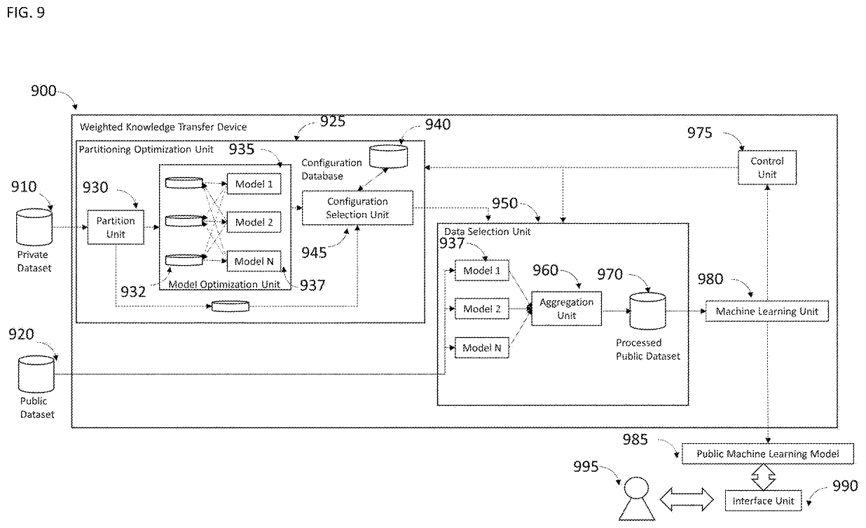

Next, an example logical configuration of a weighted knowledge transfer unit according to a second embodiment of the present disclosure will be described with reference to FIG. 9.

FIG. 9 illustrates an example logical configuration of a weighted knowledge transfer device 900 according to a second embodiment of the present disclosure. The weighted knowledge transfer device 900 according to the second embodiment of the present disclosure relates to performing a weighted knowledge transfer from a private machine learning model to a public machine learning model by optimizing a knowledge transfer capacity. As illustrated in FIG. 9, the weighted knowledge transfer device 900 according to the second embodiment of the present disclosure primarily includes a partitioning optimization unit 925, a data selection unit 950, a control unit 975, and a machine learning unit 980. The weighted knowledge transfer device 900 according to the second embodiment may be implemented using a similar system configuration as that of the previously described embodiment.

In the following, those aspects of the weighted knowledge transfer device 900 that differ from those of the previously described embodiment will be primarily described, and the description of redundant elements will be omitted.

First, the weighted knowledge transfer device 900 receives a private dataset 910 and a public dataset 920. Here, the private dataset 910 may include a collection of data that contains confidential information. For example, the private dataset 910 may include information regarding medical records, financial transactions, or personal data (names, addresses, passwords, bank account information) for one or more individuals, businesses, or other organizations (e.g., the private dataset 910 may correspond to the private dataset 102 of the previous embodiment).

The public dataset 920 may include a collection of data that contains public information. For example, the public dataset 920 may include information regarding medical records or financial transactions that are not associated with any particular individual or entity (e.g., the public dataset 920 may correspond to the public dataset 108 of the previous embodiment). In other embodiments, the private dataset 910 and the public dataset 920 may correspond to the private knowledge transfer dataset 204 and the public knowledge transfer dataset 205 of the previously described embodiment.

Next, in the partitioning optimization unit 925, the partition unit 930 divides the private dataset 910 into a plurality of partitions 932 (e.g., a first plurality of partitions). Next, the model optimization unit 935 trains and optimizes a set of private machine learning models using the plurality of partitions 932 in order to generate a set of trained private machine learning models 937. The model optimization unit 935 evaluates the performance of each of the set of trained private machine learning models 937 with respect to each partition of the plurality of partitions 932 for a variety of model parameter configurations, and stores the results in the configuration database 940.

The configuration selection unit 945 then determines a partition configuration and a set of model parameters that maximize a predetermined performance metric, such as Area Under the Curve of the Receiver Operating Characteristic (AUROC), precision, recall, or the like. The set of model parameters selected by the configuration selection unit 945 may be applied to the set of trained private machine learning models 937. The set of trained private machine learning models 937 is then communicated to the data selection unit 950.

As the logical configuration of the partitioning optimization unit 925 will be described in detail later, the description thereof will be omitted here.

The data selection unit 950 receives the public dataset 920, and uses the set of trained private machine learning models 937 to process the public dataset 920, thereby attaching a group of labels and weights to the public dataset 920. The aggregation unit 960 aggregates the group of labels and weights as a processed public dataset 970. In embodiments, the processed public dataset 970 may be selected by adjusting filtering thresholds for the attached weights. As one example, the processed public data 970 may be determined by assigning the public dataset 920 to separate partitions according to weight thresholds (for example, thresholds determined based on the group of labels and weights), training a plurality of public machine learning models, and selecting the optimal threshold and model parameters according to an evaluation metric.

The machine learning unit 980 uses the processed public dataset 970 to train a public machine learning model 985. This process may be controlled by the control unit 975, which establishes a feedback loop from the public machine learning model 985 to the partitioning optimization unit 925 and the data selection unit 950 to optimize the transfer capacity of the weighted knowledge transfer. The public machine learning model 985 may be used to provide a variety of machine-learning based services to users 995 over the interface unit 990.

In this way, the weighted knowledge transfer device 900 makes it possible to perform a weighted knowledge transfer from a private machine learning model to a public machine learning model by optimizing the knowledge transfer capacity.

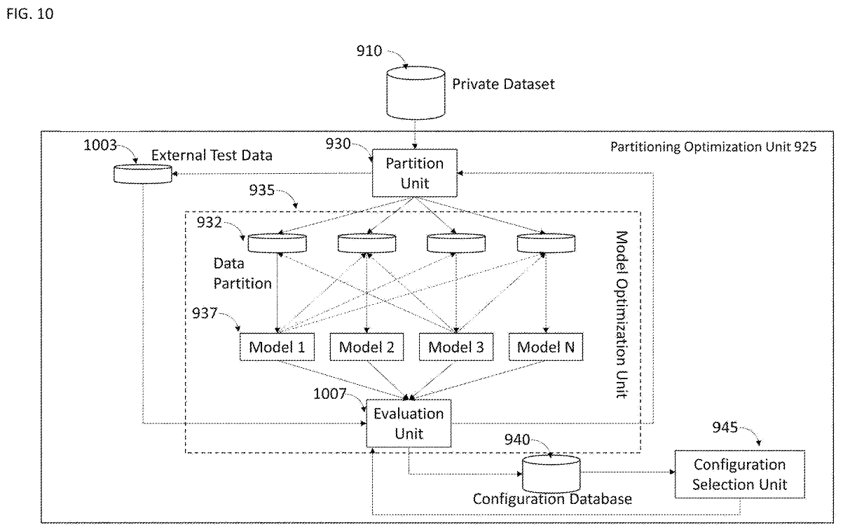

Next, an example logical configuration of the partitioning optimization unit for partitioning the private dataset and generating the set of machine learning models will be described with respect to FIG. 10.

FIG. 10 illustrates an example logical configuration of the partitioning optimization unit 925 for partitioning the private dataset 910 and generating the set of machine learning models 937, according to the second embodiment of the present disclosure.

As described herein, aspects of the disclosure relate to dividing the private dataset 910 into a plurality of partitions 932, and training a set of machine learning models using the plurality of partitions 932 in order to generate a set of trained private machine learning models 937. Here, a partition refers to a portion of the private dataset 910 that includes a mutually exclusive set of private features with respect to the other partitions of the plurality of partitions 932. In this way, data corresponding to one set of features (e.g., one patient in a healthcare context) is not distributed among multiple partitions but randomly assigned and maintained exclusively in one partition.

As illustrated in FIG. 10, first, the private dataset 910 is input to the partitioning optimization unit 925. In the partitioning optimization unit 925, the partition unit 930 divides the private dataset 910 into a plurality of partitions 932 (e.g., a first plurality of partitions) based on a set of partition constraints. Here, the set of partition constraints may include limitations, restrictions, or conditions that define how the private dataset 910 is to be distributed. As an example, the set of partition constraints may indicate that data corresponding to one set of features (e.g., one patient in a healthcare context) may not be divided between multiple partitions, but must be assigned to a single partition. Further, the partition unit 930 generates a set of external test data 1003. The set of external test data 1003 may be used to evaluate the performance of the set of trained private machine learning models 937.

Next, the model optimization unit 935 trains a set of machine learning models using the plurality of partitions 932 in order to generate a set of trained private machine learning models 937. In embodiments, the model optimization unit 935 trains each of the set of machine learning models based on a separate portion of the plurality of partitions, such that no data from other partitions is used. In this way, the performance of each machine learning model is optimized using only the data included in one partition of the plurality of partitions. Further, the model optimization unit 935 may evaluate the performance of each of the trained private machine learning models 937 with respect to the data included in other partitions of the plurality of partitions 932 (e.g., each of the trained private machine learning models 937 is evaluated with respect to data included in the partitions other than the partition on which it was trained).

Next, the evaluation unit 1007 may receive the model configuration parameters and the performance results of the evaluation of the trained private machine learning models 937 performed by the model optimization unit 935, and further evaluate the trained private machine learning models 937 with respect to the external test data 1003. The results of the performance evaluation may be stored in the configuration database 940.

Next, the configuration selection unit 945 selects the partition configuration and associated model parameters that achieve the highest performance according to some evaluation metric such as Area Under the Curve of the Receiver Operating Characteristic (AUROC), and applies them to the plurality of partitions 932 and the set of trained private machine learning models 937, respectively.

In this way, trained private machine learning models 937 for use in the weighted knowledge transfer process can be generated.

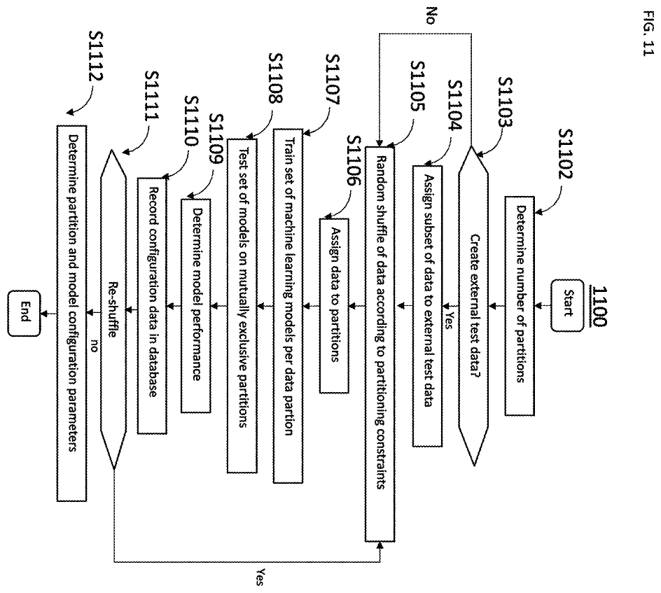

Next, a flowchart for a trained machine learning model generation process will be described with reference to FIG. 11.

FIG. 11 illustrates a flowchart of a trained machine learning model generation process 1100, according to the second embodiment of the present disclosure. The trained machine learning model generation process 1100 is a process for generating the trained private machine learning models (for example, the trained private machine learning models 937 illustrated in FIG. 9 and FIG. 10) using a plurality of partitions, and may be performed by the various function units of the weighted knowledge transfer device according to the second embodiment of the present disclosure.

First, at Step S1102, the partition unit (for example, the partition unit 930 illustrated in FIG. 9 and FIG. 10) determines a number of partitions into which to divide the private dataset (for example, the private knowledge transfer dataset 910 illustrated in FIG. 9 and FIG. 10). In embodiments, the number of partitions may be determined based on a user input. In embodiments, the number of partitions may be determined automatically based on the nature (e.g., size, number of feature sets, etc.) of the private knowledge transfer dataset.

Next, at Step S1103, the partition unit determines whether or not to create a set of external test data for use in evaluating the performance of the set of trained private machine learning models. In embodiments, the determination of whether or not to create a set of external test data may be performed based on instructions received from a user, or a pre-set performance goal criteria.

In the case that it is determined to create the set of external test data, the trained machine learning model generation process 1100 proceeds to Step S1104. In the case that it is determined not to create the set of external test data, the trained machine learning model generation process 1100 proceeds to Step S1105.

At Step S1104, the partition unit assigns a subset of the private dataset as the external test data. In embodiments, the partition unit may select a random subset of the private dataset for use as the external test data, and designate it as a separate external partition.

Next, at Step S1105, the partition unit randomly shuffles the private dataset based on the set of partitioning constrains. As described herein, the set of partition constraints include limitations, restrictions, or conditions that define how the private dataset is to be distributed. As an example, the set of partition constraints may indicate that data corresponding to one set of features (e.g., one patient in a healthcare context) may not be divided between multiple partitions, but must be assigned to a single partition. Accordingly, here, the partition unit may randomly shuffle the private dataset while satisfying the set of partitioning constraints.

Next, at Step S1106, the partitioning unit assigns the private dataset shuffled at Step S1006 into separate partitions.

Next, at Step S1107, the model optimization unit (for example, the model optimization unit 935 illustrated in FIG. 9 and FIG. 10) trains a set of machine learning models using the plurality of partitions in order to generate a set of trained private machine learning models. In embodiments, the model optimization unit trains each of the set of machine learning models based on a separate portion of the plurality of partitions, such that no data from other partitions is used. In this way, the performance of each machine learning model is optimized using only the data included in one partition of the plurality of partitions.

Next, at Step S1108, the model optimization unit evaluates the performance of each of the trained private machine learning models with respect to the data included in other partitions of the plurality of partitions. That is, each of the trained private machine learning models is evaluated with respect to data included in the partitions other than the partition on which it was trained.

Next, at Step S1109, the evaluation unit (for example, the evaluation unit 1007 illustrated in FIG. 10) determines the performance of each of the trained private machine learning models. In embodiments, the evaluation unit may evaluate the trained machined learning models with respect to the external test data created at Step S1104 and S1105, and determine the performance of each of the trained private machine learning models based on the evaluation with respect to the external test data and the performance results of the evaluation of the trained private machine learning models performed by the model optimization unit.

Next, at Step S1110, the evaluation unit stores the results of the performance evaluation determined at Step S1110 in the configuration database (for example, the configuration database 940 illustrated in FIG. 9 and FIG. 10).

Next, at Step S1111, the evaluation unit determines if the data should be re-shuffled according to constraints and re-distributed among partitions to execute another evaluation cycle. In embodiments, this determination can be performed based on a user input that specifies the evaluation of a fixed number of evaluation cycles. In other embodiments, the evaluation unit can automatically determine a stopping condition by comparing current performance results to data in the configuration database and using statistical decision making logic to determine whether or not to initiate the next evaluation cycle loop.

Next, at Step S1112, the configuration selection unit (for example, the configuration selection unit 945 illustrated in FIG. 9 and FIG. 10) analyzes the results of the performance valuation stored in the configuration database, and determines the partition configuration and associated model parameters that achieve the highest performance. Here, the configuration selection unit may determine the partition configuration and associated model parameters that achieve the highest performance using some evaluation metric such as Area Under the Curve of the Receiver Operating Characteristic (AUROC),), and apply them to the plurality of partitions 932 and the set of trained private machine learning models 937, respectively.

In this way, according to the trained machine learning model generation process 1100, trained private machine learning models for use in the weighted knowledge transfer process can be generated.

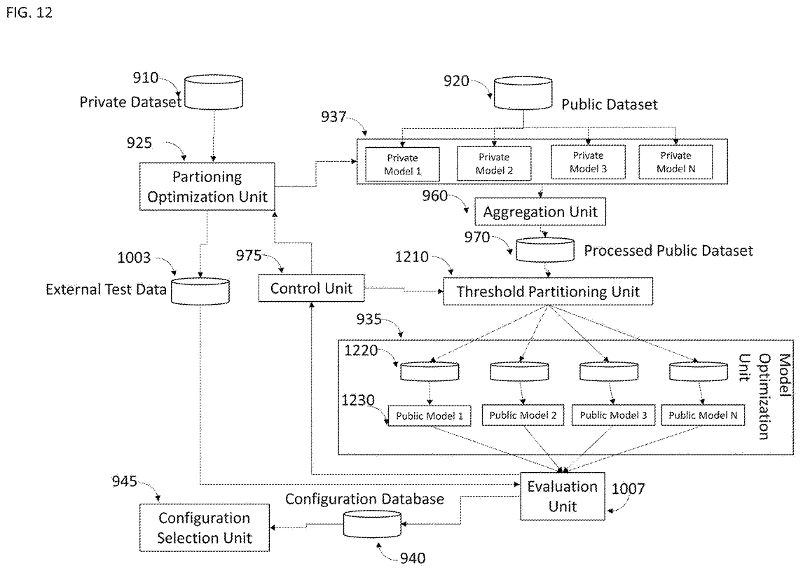

Next, the logical configuration of the weighted knowledge transfer device for data selection and optimization of a weighted knowledge transfer will be described with reference to FIG. 12.

FIG. 12 illustrates the logical configuration of the weighted knowledge transfer device according to the second embodiment for data selection and optimization of a weighted knowledge transfer.

First, as illustrated in FIG. 12, the partitioning optimization unit 925 receives a private dataset 910. The partitioning optimization unit 925 divides the private dataset 910 into a plurality of partitions (e.g., a first plurality of partitions, such as the plurality of partitions 932 illustrated in FIG. 9 and FIG. 10; not illustrated in FIG. 12), and generates a set of external test data 1003. The partitioning optimization unit 925 trains and optimizes a set of private machine learning models using the plurality of partitions in order to generate a set of trained private machine learning models 937.

Next, the public dataset 920 is processed by the set of trained private machine learning models and their outputs (e.g., group of labels and weights) are aggregated by the aggregation unit 960 to produce the processed public dataset 970. The processed public dataset 970 is input to the threshold partitioning unit 1210. The threshold partitioning unit 1210 divides the processed public dataset 970 data into a second plurality of partitions 1220 according to a set of thresholds determined based on the group of labels and weights. This set of thresholds can be used to filter the processed public dataset 970 according to the weights assigned thereto. Here, the partitioning of the processed public dataset 970 may be performed based on the data thresholding optimization process described later.

Next, the model optimization unit 935 trains a set of public models using the second plurality of partitions 1220 to generate a set of trained public machine learning models 1230. Here, the model optimization unit 935 may train the set of public models such that each of the public models are trained on a different partition of the plurality of partitions 1220.

The evaluation unit 1007 evaluates the performance of the set of trained public machine learning models 1230 using the external test data 1003 and records the results in the configuration database 940.

The configuration selection unit 945 selects the thresholds, model, and model parameters that achieve the highest performance in the weighted knowledge transfer, and applies them. In embodiments, one or more of the models among the set of trained public machine learning models 1230 may be selected for deployment to users via an interface unit (not shown in FIG. 12).

The control unit 975 is used to combine the data partition process and data selection process with the threshold-based optimization process. In this way, weighted knowledge transfer performance can be maximized by simultaneously optimizing and determining a partition scheme for a public dataset public data, parameter configurations for sets of private and public machine learning models, and weights and weighting thresholds for selecting a the processed public dataset.

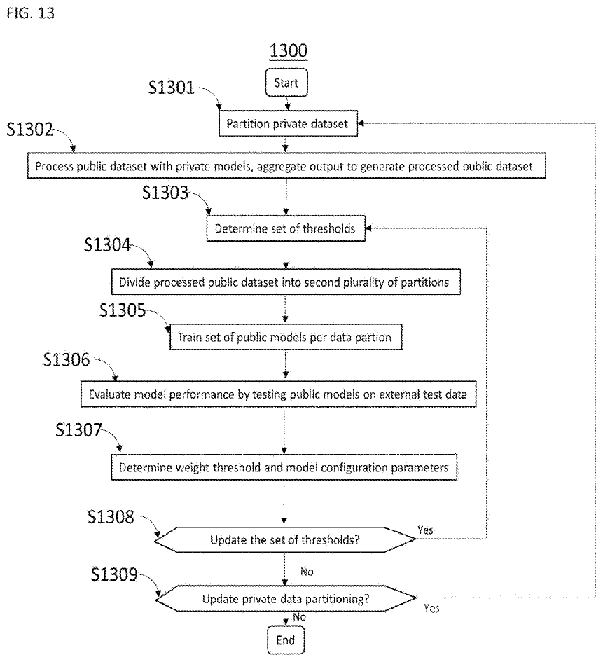

Next, a flowchart of a data thresholding optimization process will be described with reference to FIG. 13.

FIG. 13 illustrates a flowchart of a data thresholding optimization process 1300, according to the second embodiment of the present disclosure. The data thresholding optimization process 1300 is a process for determining the set of thresholds to be used in partitioning the processed public data, and may be performed by the various functional units of the weighted knowledge transfer device according to the second embodiment.

First, at Step S1301, the partitioning optimization unit (for example, the partitioning optimization unit 925 illustrated in FIG. 9, FIG. 10, and FIG. 12) divides the private dataset into a plurality of partitions, and generates a set of external test data. The partitioning optimization unit 925 trains and optimizes a set of private machine learning models using the plurality of partitions in order to generate a set of trained private machine learning models.

Next, at Step S1302, the public dataset is processed by the set of trained private machine learning models and their outputs (e.g., a group of labels and weights) are aggregated by the aggregation unit 960 to produce the processed public dataset 970.

Next, at Step S1303, the threshold partitioning unit (for example, the threshold partitioning unit 1210 illustrated in FIG. 12) determines a set of thresholds for filtering the processed public dataset according to the weights assigned thereto. In embodiments, the set of thresholds may be determined based on the weights generated by processing the public dataset with the set of trained private machine learning models in Step S1302. In other embodiments, the set of thresholds may be initially set by a user or administrator of the weighted knowledge transfer system, and updated by subsequent steps of the data thresholding optimization process 1300.

Next, at Step 1304, the threshold partitioning unit divides the processed public dataset data into a second plurality of partitions according to the set of thresholds which are used to filter the processed public dataset according to the weights assigned thereto.

Next, at Step S1305, the model optimization unit (for example, the model optimization unit 935 illustrated in FIG. 10 and FIG. 12) trains a set of public models using the second plurality of partitions created at Step S1304 to generate a set of trained public machine learning models. Here, the model optimization unit may train the set of public models such that each of the public models are trained on a different partition of the plurality of partitions.

Next, at Step S1306, the evaluation unit (for example, the evaluation unit 1007 illustrated in FIG. 10 and FIG. 12) evaluates the performance of the set of trained public machine learning models using the external test data and records the results in the configuration database.

Next, at Step S1307, the configuration selection unit (for example, the configuration selection unit 945 illustrated in FIG. 10 and FIG. 12) selects the weight thresholds, model, and model parameters that achieve the highest performance in the weighted knowledge transfer.

Next, at Step S1308, the control unit (for example, the control unit 975 illustrated in FIG. 10 and FIG. 12) determines whether or not to update the set of thresholds. In embodiments, the control unit may perform the determination of whether or not to update the set of thresholds based on the performance of the set of trained public machine learning models. For instance, in the event that the set of trained public machine learning models fail to achieve a designated performance criterion, the control unit may update the set of thresholds to facilitate the creation of data partitions predicted to provide increased performance.

In the case that the control unit determines to update the set of thresholds, the data thresholding optimization process 1300 may return to Step S1303. In the case that the control unit determines not to update the set of thresholds, the data thresholding optimization process may proceed to Step S1309.

Next, at Step S1309, the control unit determines whether or not to update the plurality of partitions. For example, the control unit may divide the private dataset based on new partition constraints created based on the performance of the set of trained public machine learning models.

In this way, according to the weighted knowledge transfer device 900 according to the second embodiment of the present disclosure, machine learning models can be trained using optimal data partitions, allowing for knowledge transfer capacity to be maximized. The weighted knowledge transfer device 900 may be associated with additional performance and efficiency benefits with respect to the weighted knowledge transfer device according to the previous embodiment.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

### REFERENCE SIGNS LIST

100 . . . Weighted knowledge transfer system
101 . . . Private device
102 . . . Private dataset
103 . . . Private machine learning model
104 . . . Weighted knowledge transfer device
105 . . . Weighted knowledge transfer unit
106 . . . Public device
107 . . . Public machine learning model
108 . . . Public dataset
109 . . . Interface unit
110, 111, 112 . . . Interface
113 . . . User
203 . . . Feature determination unit
204 . . . Private knowledge transfer dataset
205 . . . Public knowledge transfer dataset
206 . . . Data selection unit
207 . . . Public training dataset
208 . . . Similarity weight vector

1. A weighted knowledge transfer device comprising:
a feature determination unit configured to generate a public knowledge transfer dataset and a private knowledge transfer dataset by determining a set of target features shared between a public dataset and a private dataset;
a data selection unit configured to generate, based on a similarity calculation of the public knowledge transfer dataset and the private knowledge transfer dataset:
a public training dataset which is a subset of the public knowledge transfer dataset that achieves a similarity threshold with respect to the private knowledge transfer dataset, and
a similarity weight vector that indicates weights of a set of public features included in the public training dataset;
a machine learning model management unit configured to generate, by processing the public training dataset with a set of trained private machine learning models trained based on the private knowledge transfer dataset, a public label vector that indicates labels for the set of public features; and
a knowledge transfer unit configured to generate a public machine learning model based on the weight vector, the public training dataset, and the public label vector.

2. The weighted knowledge transfer device according to claim 1, further comprising:
a partition unit configured to divide the private knowledge transfer dataset into a plurality of partitions; and
wherein each partition includes a mutually exclusive set of private features with respect to other partitions.

3. The weighted knowledge transfer device according to claim 2, wherein:
the machine learning model management unit generates the set of trained private machine learning models by training each of a set of machine learning models based on a separate partition of the plurality of partitions.

4. The weighted knowledge transfer device according to claim 1, wherein generating the public training dataset includes:
generating a trained generator network by training a generator network with the private knowledge transfer dataset to generate a first set of generated features;
generating a trained discriminator network by training a discriminator network to distinguish between the first set of generated features and a set of private features included in the private knowledge transfer dataset;
determining, using the trained discriminator network, a probability of the first set of generated features belonging to the private knowledge transfer dataset; and
selecting, as the public training dataset, a subset of the set of generated features associated with a probability of belonging to the private knowledge transfer dataset that exceeds a first probability threshold.

5. The weighted knowledge transfer device according to claim 1, wherein generating the public training dataset includes:
merging the private knowledge transfer dataset and the public knowledge transfer dataset into a merged dataset;
generating a trained discriminator network by training a discriminator network to classify a first set of features of the merged dataset as belonging to the private knowledge transfer dataset or the public knowledge transfer dataset;
determining, by using the trained discriminator network to process the public knowledge transfer dataset, a probability indicating a likelihood that the set of public features belongs to the private knowledge transfer dataset; and
selecting, as the public training dataset, a subset of the set of public features associated with a probability of belonging to the private knowledge transfer dataset that exceeds a first probability threshold.

6. The weighted knowledge transfer device according to claim 1, wherein the similarity calculation is selected from the group consisting of a Euclidean distance calculation method, a Manhattan distance calculation method, a Chebyshev distance calculation method, and a Mahalanobis distance calculation method.

7. A weighted knowledge transfer method comprising:
receiving a public dataset and a private dataset;
generating a public knowledge transfer dataset and a private knowledge transfer dataset by determining a set of target features shared between the public dataset and the private dataset;
generating, based on a similarity calculation of the public knowledge transfer dataset and the private knowledge transfer dataset:
a public training dataset which is a subset of the public knowledge transfer dataset that achieves a similarity threshold with respect to the private knowledge transfer dataset, and
a similarity weight vector that indicates weights of a set of public features included in the public training dataset;
generating, by training a set of machine learning models with the private knowledge transfer dataset, a set of trained private machine learning models;
generating, by processing the public training dataset with the set of trained private machine learning models, a public label vector that indicates labels for the set of public features; and
generating a public machine learning model based on the weight vector, the public training dataset, and the public label vector.

8. A weighted knowledge transfer system comprising:
a private device that stores a private dataset;
a public device configured to include a public dataset and provide machine learning model based services to users; and
a weighted knowledge transfer device configured to generate a set of trained public machine learning models using the private dataset and the public dataset,
wherein:
the weighted knowledge transfer device is communicably connected to the private device via a first network connection;
the weighted knowledge transfer device is communicably connected to the public device via a second network connection different than the first network connection;
the private device is inaccessible from the public device;
the weighted knowledge transfer device includes:
a partitioning optimization unit configured to:
divide the private dataset into a first plurality of partitions, and
generate a set of trained private machine learning models by training each of a set of machine learning models based on a separate partition of the first plurality of partitions;
a data selection unit configured to:
generate, as a processed public dataset, a group of labels and weights created by processing the public dataset using the set of trained private machine learning models,
divide the processed public dataset into a second plurality of partitions based on a set of thresholds determined based on the group of labels and weights; and
a machine learning unit configured to:
generate a set of trained public machine learning models by training each of a set of machine learning models based on a separate partition of the second plurality of partitions, and deploy the set of trained public machine learning models to the public device for provision to users.

9. The weighted knowledge transfer system according to claim 8, further comprising:
an evaluation unit configured to:
evaluate a performance of the set of trained private machine learning models with respect to a set of external test data selected from the private dataset; and
determine, based on the performance of the set of trained private machine learning models with respect to the set of external test data selected from the private dataset, a first set of model configuration parameters for the set of trained private machine learning models that achieves a predetermined performance criterion.

10. The weighted knowledge transfer system according to claim 9, wherein the evaluation unit is further configured to:
evaluate a performance of the set of trained public machine learning models with respect to a set of external test data selected from the private dataset; and
determine, based on the performance of the set of trained private machine learning models with respect to the set of external test data selected from the private dataset, a second set of model configuration parameters for the set of trained public machine learning models that achieves a predetermined performance criterion.
